(19) United States
(12) Patent Application Publication
(10) Pub. No.: US 2007/0190211 A1
(43) Pub. Date: Aug. 16, 2007

(54) Milk mineral water, processes for manufacturing thereof and beverages containing milk mineral water

(76) Inventors: Torben Lohse Friis, Viby J (DK); Hans Henrik Holst, Viby J (DK); Karsten Jeppesen, Viby J (DK); Katrine Nymark, Viby J (DK); Carsten Hallund Slot, Viby J (DK); Karsten Lauritzen, Viby J (DK)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/638,434

(22) Filed: Dec. 14, 2006

Related U.S. Application Data
(60) Provisional application No. 60/750,401, filed on Dec. 15, 2005.
(60) Provisional application No. 60/800,046, filed on May 15, 2006.
(60) Provisional application No. 60/832,159, filed on Jul. 21, 2006.

(51) Int. Cl. A23C 9/14

(52) U.S. Cl. 426/239

(57) ABSTRACT

Milk mineral water having a low energy level, manufacturing thereof using different filtration methods and beverages containing such mineral water as essentially sole liquid.

### FIELD OF THE INVENTION

The present invention relates to a milk mineral water in the form of a solely milk based liquid with characteristics of mineral water, processes for manufacturing thereof and a beverage containing such a milk mineral water.

### BACKGROUND OF THE INVENTION

There is a potential need for a drink which contains beneficial minerals from bovine milk, but without the energy input, flavour or colour that are natural for normal consumer's milk. This potential is illustrated by the well-documented fact that young people, as they grow older, switch from drinking milk to drinking water or soft drinks—without fulfilling their need for calcium.

Thus, there is great potential in succeeding to produce and commercialize a clear liquid or drink giving the same benefits as water (distribution, energy input, flavour, and taste) and simultaneously giving the consumer the calcium normally contained in consumer's milk.

### SUMMARY OF THE INVENTION

The object of the invention is to produce a milk mineral water, where all the ingredients are dairy based. The liquid has sensory and shelf life properties similar to known bottled mineral water. It can be used in other beverages with different additives.

### DETAILED DESCRIPTION OF THE INVENTION

The milk mineral water of the invention is a solely bovine milk based liquid with the characteristics of mineral water and having a calcium level between 0.1% and 200% of the calcium level of skimmed milk, a protein level between 0.05% and 2% of the normal protein level of skimmed milk, a fat level of between 0.01% and 5% of the normal fat level of skimmed milk and a lactose level of between 0.01% and 4% of the normal lactose level of skimmed milk.

The energy level of such a liquid is between 0.01 and 10 kcal per 100 g.

It is normally desired to have the levels of protein, lactose and fat as low as practically possible due to the desired low energy level. However, there can be situations, where a certain content can be preferred due to the taste or dependant on optionally further additives and special utilisations.

Preferably the milk mineral water has a calcium level between 0.1% and 120% of the calcium level of skimmed milk, a protein level between 0.1% and 1.75% of the normal protein level of skimmed milk, a fat level between 0.01% and 4% of the normal fat level of skimmed milk and a lactose level between 0.01% and 2% of the normal lactose level of skimmed milk.

The energy level of such a milk mineral water is between 0.01 and 5 kcal per 100 g.

One of the processes of the invention for manufacturing of a liquid of claim 1 comprises reverse osmosis of milk, sweet whey or acid whey, alternatively a milk, sweet whey or acid whey based ultrafiltration (UF) permeate.

A preferred reverse osmosis membrane for this process has a pore size between 10⁻⁴ and 10⁻³ micron.

Another process for manufacturing of a liquid of claim 1 comprises nanofiltration of milk, sweet whey or acid whey, alternatively a milk, sweet whey or acid whey based ultrafiltration (UF) permeate.

A preferred nanofiltration membrane for this process has a pore size between 10⁻³ and 10⁻² micron.

A third process for manufacturing of a liquid of claim 1 comprises nanofiltration of milk, sweet whey or acid whey, alternatively a milk, sweet whey or acid whey based ultrafiltration (UF) permeate mixed with either a milk, sweet whey or acid whey based evaporation condensate or alternatively a milk, sweet whey or acid whey based reverse osmosis (RO) permeate.

It is also possible to combine such processes.

In all such processes a natural milk mineral concentrate can be added to the desired level, unless the level already is as preferred. “Capolac” from Arla Foods, Denmark can be used.

Further details of the manufacturing processes can be found in the examples.

A milk mineral water of claim 1 can be used directly as mineral water or it can be used as essentially sole liquid combined with one or more of the following ingredients in beverages: a natural milk mineral concentrate, a food grade acid, a food grade sweetener, a food grade colorant, a food grade flavouring agent, a fruit juice, a fruit pulp, vitamins, plant extracts and carbonization.

A beverage containing a milk mineral water of claim 1 as sole liquid can be a soft drink, a food supplement or a natural medicinal product.

Manufacturing of the milk mineral water can thus be performed by a number of methods, such as:
Producing a permeate from reverse osmosis of milk, sweet whey or acid whey, alternatively a milk, sweet whey or acid whey based ultrafiltration (UF) permeate.
Producing a permeate from nanofiltration of milk, sweet whey or acid whey, alternatively a milk, sweet whey or acid whey based ultrafiltration (UF) permeate.
Two or more permeate types from filtration of different milk products may be mixed in a ratio from 0% to 100%.

Furthermore, as mentioned above, one or more of the following ingredients may be added: a natural milk mineral concentrate, a food grade acid, a food grade sweetener, a food grade colorant, a food grade flavouring agent, a fruit juice, a fruit pulp, vitamins, plant extracts and carbonization.

The process is to concentrate milk, sweet whey, acid whey or ultrafiltration permeate from milk, sweet whey or acid whey on a nanofiltration membrane with a membrane pore size between 10⁻³ micron and 10⁻² micron, alternatively on a reverse osmosis membrane with a membrane pore size between 10⁻⁴ micron and 10⁻³ micron

Thereby, a clear liquid is obtained.

The liquid can thereafter, optionally after addition of milk mineral condensate or other additives, be heat-treated, e.g. in normally dairy equipment for heat-treatment of milk products.

Condensate from milk, sweet whey or acid whey evaporation may be added in a ratio of between 30% and 70%.

Furthermore the obtained liquid can be submitted to one or more of the following treatments:
addition of a food grade flavour
pH adjustment with a food grade acid, preferably lactic acid or citric acid, to pH 7.0-3.0 (7.0, 6.5, 6.0, 5.5, 5.0, 4.5, 4.0, 3.5, 3.0)
addition of a natural milk mineral concentrate (e.g. Capolac from Arla Foods) to achieve a calcium level of 0.1%-200% (0.1%, 0.5% 1%, 5%, 10%, 25%, 50%, 75%, 100%, 125%, 150%, 175% or 200%) of the natural level of skimmed milk.

The normal content of calcium in milk is about 116 mg/100 g for whole milk (between 63 mg/100 g and 149 mg/100 g due to variations in fat content from animal to animal), whereas the content in skim milk is about 124 mg/100 g (with a natural variation of 114-134 mg/100 g). Therefore skimmed milk is chosen as standard in the present application. It is possible to add more natural milk mineral concentrate. However, addition of too much will negatively affect the product taste.

The mineral water of the invention, solely based on dairy products, can be used in a beverage in the form of a soft drink, a food supplement, including a probiotic or prebiotic food supplement, or a natural medicinal product.

For such a beverage one or more of the following additives can be used:
a food grade bulk sweetener
a food grade high intensity sweetener
a food grade colorant
a fruit pulp
a probiotic
a prebiotic
dairy based proteins, peptides and amino acids
vegetable based proteins, peptides and amino acids
vitamins
dietary supplement e.g. ginseng, taurin, gingko biloba, green tea and aloe vera

The above mentioned list is a non limiting list, not excluding other additives.

This final product is heat-treated, preferably HTST pasteurized, followed by filling/closing.

### ABBREVIATIONS AND DEFINITIONS

TS=Total Solids, equal to DM=Dry Matter

NF=Nanofiltration

UF=Ultrafiltration

RO=Reverse Osmosis

Sweet whey=whey with pH above pH 5.6

Acid whey=whey with pH below pH 5.1

Casein whey=whey from production of casein

HTST=high temperature short time

Milk mineral water=mineral water based solely on dairy products, such as milk, skimmed milk, sweet whey and acid whey as well as ultrafiltration (UF) permeates thereof.

Sole liquid=essentially sole liquid. This term is used for beverages of the invention and means that the beverage does not contain another liquid than the milk mineral water except for minor amounts of liquid from added extracts, flavours or the like additives.

Probiotics=live microorganisms which, when administered in adequate amounts, confer a health benefit on the host.

Prebiotics=food substances which promote the growth of certain bacteria (generally probiotics) in the intestines.

Absorbance=absorbance measured in a 1 cm. cuvette at 500 nm.

Reference: demineralised water.

The present invention is further explained in the following non limiting examples.

### The drawing shows the flow sheets for each example:

FIG. 1 is the flow sheet for example 1.

FIG. 2 is the flow sheet for example 2.

FIG. 3 is the flow sheet for example 3.

FIG. 4 is the flow sheet for example 4.

FIG. 5 is the flow sheet for example 5.

FIG. 6 is the flow sheet for example 6.

FIG. 7 is the flow sheet for example 7.

FIG. 8 is the flow sheet for example 8.

FIG. 9 is the flow sheet for example 9.

FIG. 10 is the flow sheet for example 10.

### EXAMPLE 1

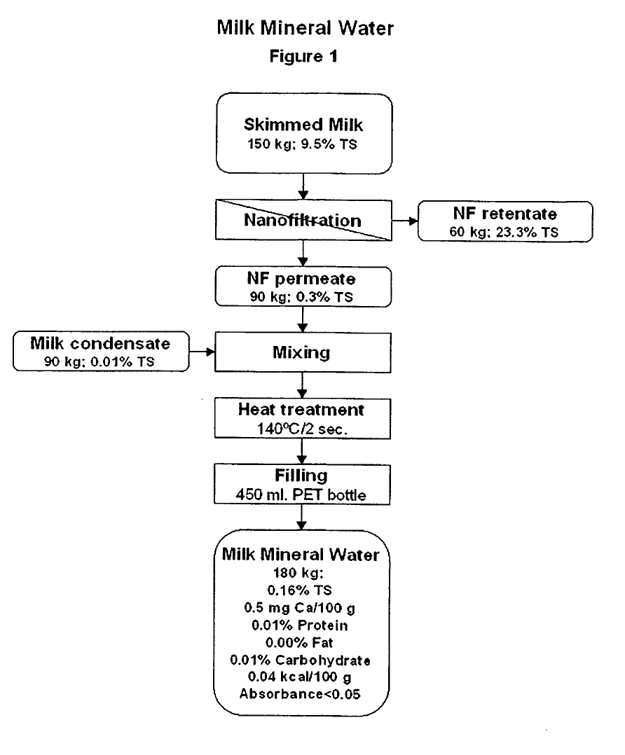

Ref.: FIG. 1
150 kg of skimmed milk (9.5% TS) are processed on a filtration unit equipped with NF membranes (Osmonics; cut-off: 200 MW). The concentration ratio is 1:2.5, resulting in 60 kg of nanofiltration retentate (23.3% TS) and 90 kg of NF permeate (0.3% TS).
The 90 kg of NF permeate are mixed with 90 kg of condensate from skimmed milk evaporation (0.01% TS), taken from the first stage in a 3-stage evaporator from Anhydro A/S.
The above mentioned liquid is heat-treated at 140° C. for 2 seconds, followed by filling into clear PET bottles, each containing 450 ml.

### EXAMPLE 2

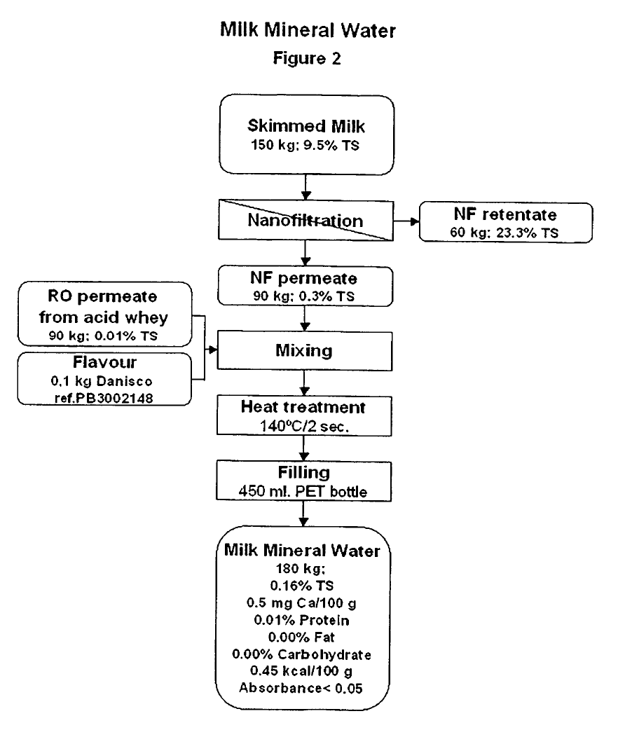

Ref.: FIG. 2
150 kg of skimmed milk (9.5% TS) are processed on a filtration unit equipped with NF membranes (Osmonics; cut-off: 200 MW). The concentration ratio is 1:2.5, resulting in 60 kg of NF retentate (23.3% TS) and 90 kg of NF permeate (0.3% TS).
The 90 kg of NF permeate are mixed with 90 kg of RO permeate from reverse osmosis of acid casein whey (0.01% TS).
Then a flavour compound (0.1 kg. Lime, ref. PB3002148 from Danisco Ingredients) is added.
Finally, the above mentioned liquid is heat-treated at 140° C. for 2 seconds, followed by filling into clear PET bottles, each containing 450 ml.

### EXAMPLE 3

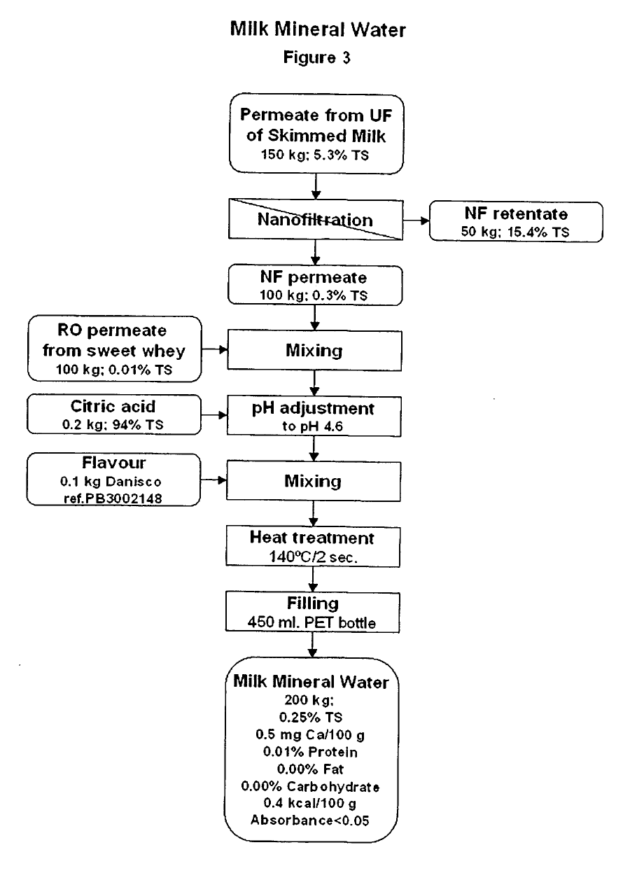

Ref.: FIG. 3
150 kg of UF permeate from skimmed milk (5.3% TS) was processed on a filtration unit equipped with NF membranes (Osmonics; cut-off: 200 MW). The concentration ratio was 1:3, resulting in 50 kg of NF retentate (15.4% TS) and 100 kg of NF permeate (0.3% TS).
The 100 kg of NF permeate was mixed with 100 kg of RO permeate from reverse osmosis of sweet whey (0.01% TS).
The above mentioned mix of NF permeate and RO permeate was pH adjusted by adding citric acid, until pH 4.6 was achieved.
Then a flavour compound (0.1 kg. Lime, ref. PB3002148 from Danisco Ingredients) was added.

Finally, the above mentioned liquid was heat-treated at 140° C. for 2 seconds, followed by filling into clear PET bottles, each containing 450 ml.

### EXAMPLE 4

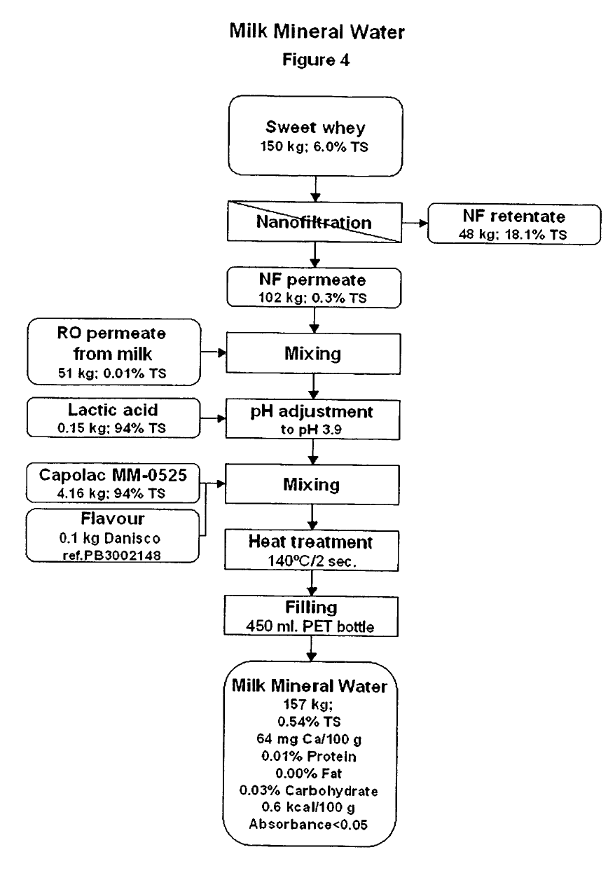

Ref.: FIG. 4
150 kg of sweet whey (6.0% TS) are processed on a filtration unit equipped with NF membranes (Osmonics; cut-off: 200 MW). The concentration ratio is 1:3, resulting in 48 kg of NF retentate (18.1% TS) and 102 kg of NF permeate (0.3% TS).
The 102 kg of NF permeate are mixed with 51 kg of RO permeate from reverse osmosis of skimmed milk (0.01% TS).
The above mentioned mix of NF permeate and RO permeate is pH adjusted by adding lactic acid, until pH 3.9 is achieved.
The next step is to dissolve 4.16 kg of milk calcium concentrate (Capolac MM0525 from Arla Foods) into the pH adjusted liquid.
Then a flavour compound (0.1 kg. Lime, ref. PB3002148 from Danisco Ingredients) is added.

Finally, the above mentioned liquid is heat-treated at 140′ C. for 2 seconds, followed by filling into clear PET bottles, each containing 450 ml.

### EXAMPLE 5

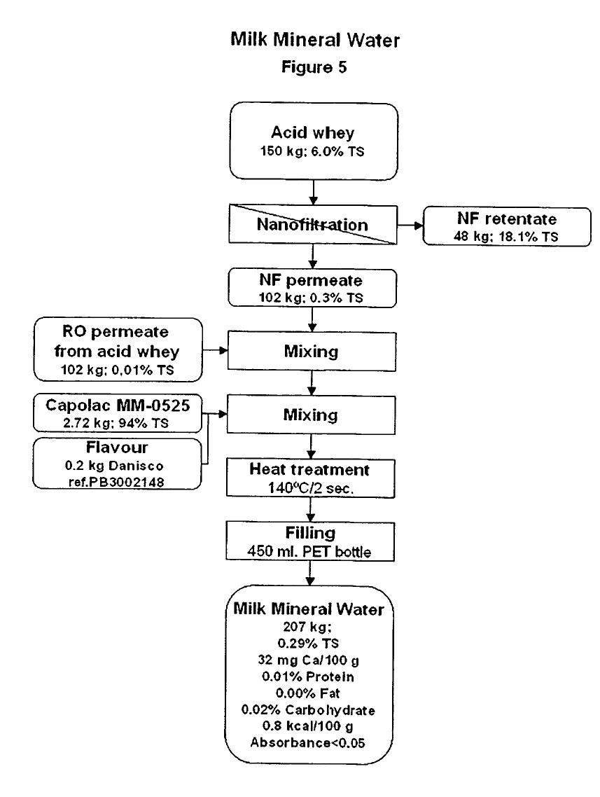

Ref.: FIG. 5
150 kg of acid whey (6.0% TS) are processed on a filtration unit equipped with NF membranes (Osmonics; cut-off: 200 MW). The concentration ratio is 1:3, resulting in 48 kg of NF retentate (18.1% TS) and 102 kg of NF permeate (0.3% TS).
The 102 kg of NF permeate are mixed with 102 kg of RO permeate from reverse osmosis of acid whey (0.01% TS).
The next step is to dissolve 2.72 kg of milk calcium concentrate (Capolac MM0525 from Arla Foods) into the liquid.
Then a flavour compound (0.2 kg. Lime, ref. PB3002148 from Danisco Ingredients) is added.
Finally, the above mentioned liquid is heat-treated at 140° C. for 2 seconds, followed by filling into clear PET bottles, each containing 450 ml.

### EXAMPLE 6

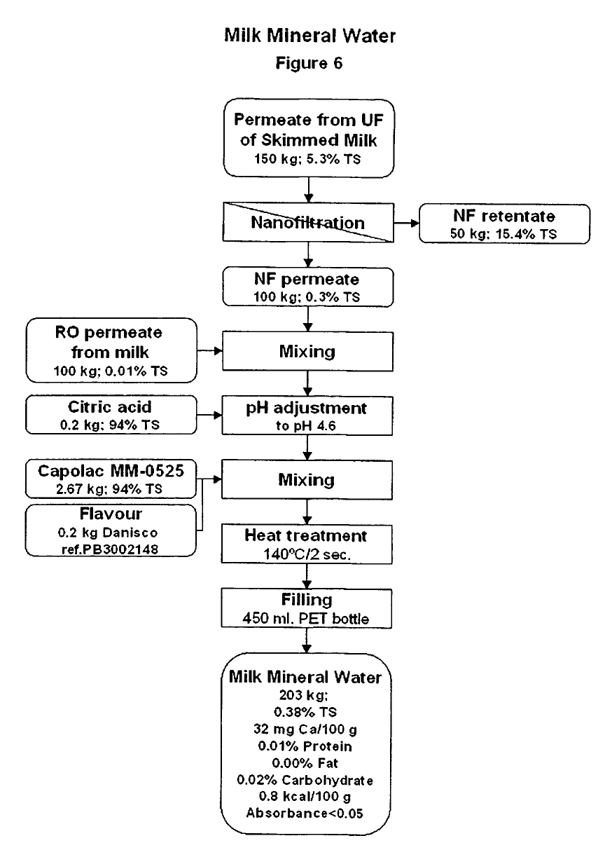

Ref.: FIG. 6
150 kg of UF permeate from ultrafiltration of skimmed milk (5.3% TS) was processed on a filtration unit, equipped with NF membranes (Osmonics; cut-off: 200 MW). The concentration ratio was 1:3, resulting in 50 kg of NF retentate (15.4% TS) and 100 kg of NF permeate (0.3% TS).
The 100 kg of NF permeate was mixed with 100 kg of RO permeate from reverse osmosis of skimmed milk (0.01% TS).
The above mentioned mix of NF permeate and RO permeate was pH adjusted by adding citric acid, until pH 4.6 was achieved.
The next step was to dissolve 2.67 kg of milk calcium concentrate (Capolac MM0525 from Arla Foods) into the pH adjusted liquid.
Then a flavour compound (0.2 kg. Lime, ref. PB3002148 from Danisco Ingredients) was added.

Finally, the above mentioned liquid was heat-treated at 140° C. for 2 seconds, followed by filling into clear PET bottles, each containing 450 ml.

### EXAMPLE 7

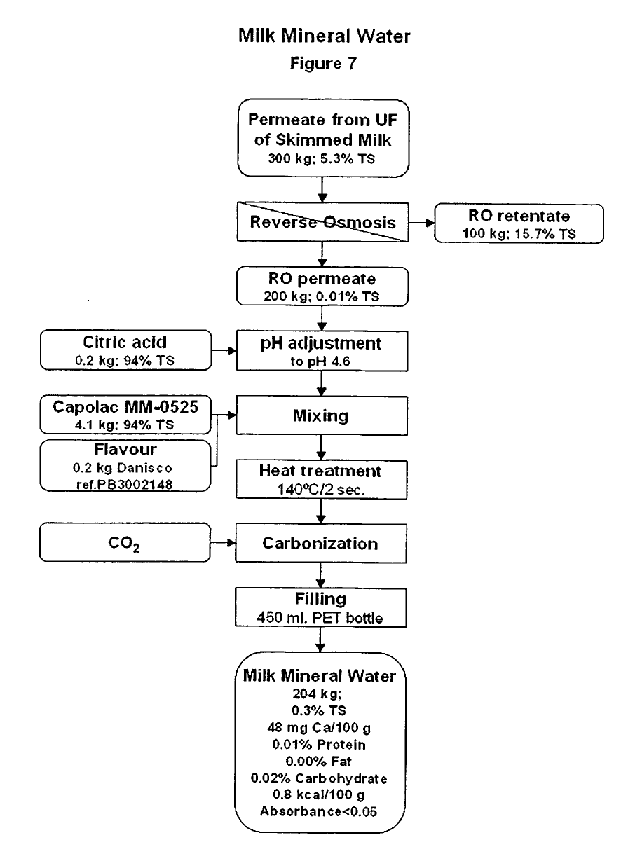

Ref.: FIG. 7
300 kg of UF permeate from ultrafiltration of skimmed milk (5.3% TS) was processed on a filtration unit, equipped with RO membranes (Osmonics; cut-off: 50 MW). The concentration ratio was 1:3, resulting in 100 kg of RO retentate (15.7% TS) and 200 kg of RO permeate (0.01% TS).
The 200 kg of RO permeate was pH adjusted by adding citric acid, until pH 4.6 was achieved.
The next step was to dissolve 4.1 kg of milk calcium concentrate (Capolac MM0525 from Arla Foods) into the pH adjusted liquid.
Then a flavour compound (0.2 kg. Lime, ref. PB3002148 from Danisco Ingredients) was added.

Finally, the above mentioned liquid was heat-treated at 140° C. for 2 seconds, followed by carbonisation and filling into clear PET bottles, each containing 450 ml.

### EXAMPLE 8

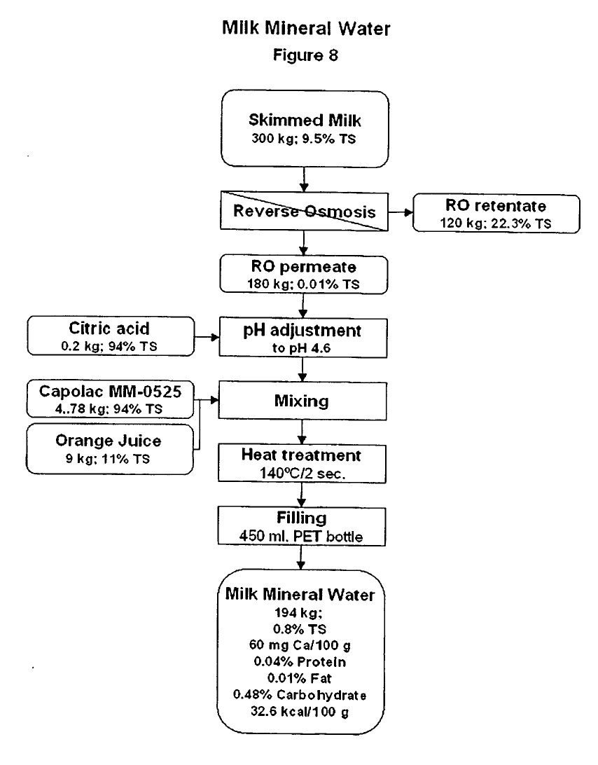

Ref.: FIG. 8
300 kg of skimmed milk (9.5% TS) are processed on a filtration unit equipped with RO membranes (Osmonics; cut-off: 50 MW). The concentration ratio is 1:2.5, resulting in 120 kg of RO retentate (22.3% TS) and 180 kg of RO permeate (0.01% TS).
The above mentioned RO permeate is pH adjusted by adding citric acid, until pH 4.6 is achieved.
The next step is to dissolve 4.78 kg of milk calcium concentrate (Capolac MM0525 from Arla Foods) into the pH adjusted liquid.
9 kg of orange juice are mixed in.
Finally, the above mentioned liquid is heat-treated at 140° C. for 2 seconds, followed by filling into clear PET bottles, each containing 450 ml.

### EXAMPLE 9

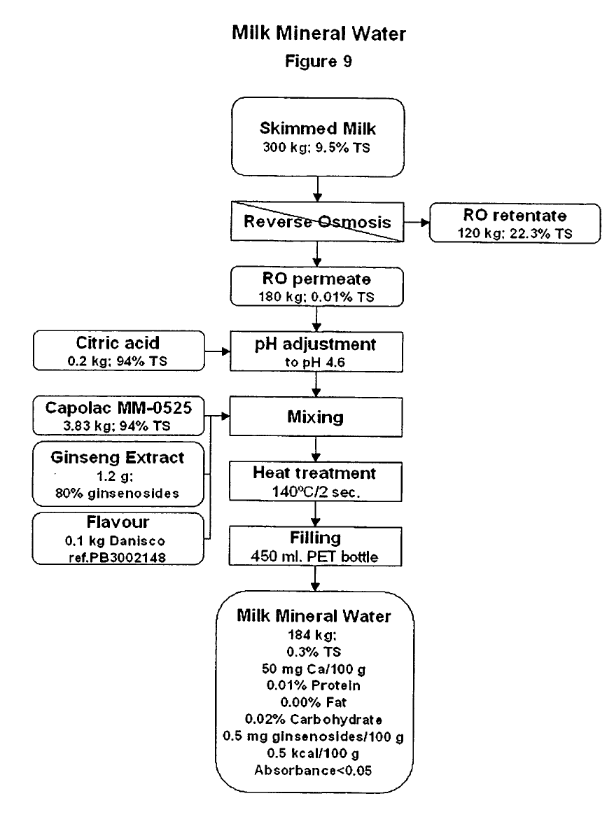

Ref.: FIG. 9
300 kg of skimmed milk (9.5% TS) are processed on a filtration unit equipped with RO membranes (Osmonics; cut-off: 50 MW). The concentration ratio is 1:2.5, resulting in 120 kg of RO retentate (22.3% TS) and 180 kg of RO permeate (0.01% TS).
The above mentioned RO permeate is pH adjusted by adding citric acid, until pH 4.6 is achieved.
The next step is to dissolve 3.83 kg of milk calcium concentrate (Capolac MM0525 from Arla Foods) into the pH adjusted liquid.

Then a flavour compound (0.1 kg. Lime, ref. PB3002148 from Danisco Ingredients) plus a ginseng extract (1.2 g; 80% ginsenosides) is added.
Finally, the above mentioned liquid is heat-treated at 140′ C. for 2 seconds, followed by filling into clear PET bottles, each containing 450 ml.

### EXAMPLE 10

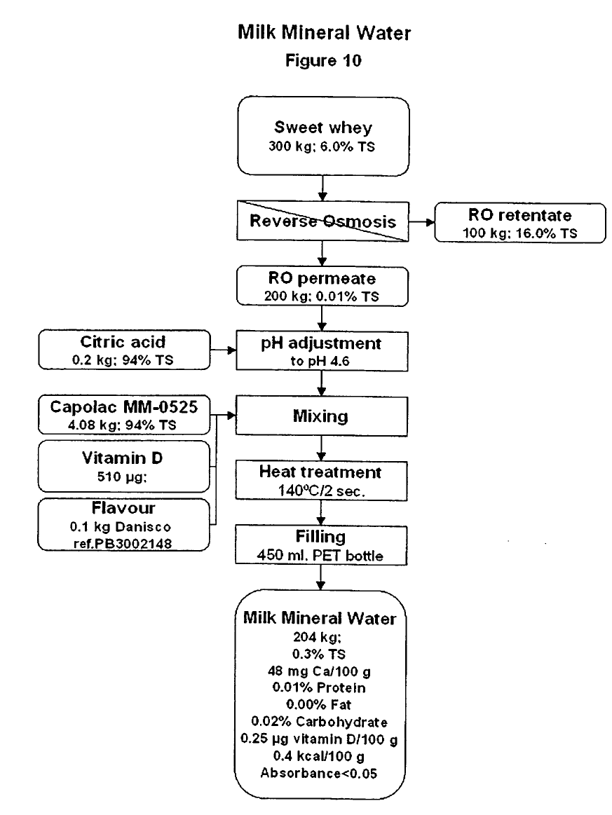

Ref.: FIG. 10
300 kg of sweet whey (6.0% TS) are processed on a filtration unit equipped with RO membranes (Osmonics; cut-off: 50 MW). The concentration ratio is 1:3, resulting in 100 kg of RO retentate (16.0% TS) and 200 kg of RO permeate (0.01% TS).
The above mentioned RO permeate is pH adjusted by adding citric acid, until pH 4.6 is achieved.
The next step is to dissolve 4.08 kg of milk calcium concentrate (Capolac MM0525 from Ada Foods) into the pH adjusted liquid.
Then a flavour compound (0.2 kg. Lime, ref. PB3002148 from Danisco Ingredients) plus a vitamin D extract (510 mg; 80% ginsenosides) is added.
Finally, the above mentioned liquid is heat-treated at 140° C. for 2 seconds, followed by filling into clear PET bottles, each containing 450 ml.

1. A milk mineral water solely based on dairy products, wherein the calcium level is between 0.1% and 200% of the calcium level of skimmed milk., the protein level is between 0.05% and 2% of the normal protein level of skimmed milk, the fat level of between 0.01% and 5% of the normal fat level of skimmed milk, and the lactose level is 0.01% and 4% of the level of skimmed milk.

2. A milk mineral water of claim 1, wherein the calcium level is between 0.1% and 120% of the calcium level of skimmed milk, the protein level is between 0.1% and 1.75% of the normal protein level of skimmed milk, the fat level is between 0.01% and 4% of the normal fat level of skimmed milk and the lactose level is between 0.01% and 2% of the normal lactose level of skimmed milk.

3. A process for manufacturing of a milk mineral water of claim 1 by nanofiltration of milk, sweet whey or acid whey, alternatively a milk, sweet whey or acid whey based ultrafiltration (UF) permeate.

4. A process of claim 3, wherein the nanofiltration membrane has a pore size between 10⁻³ and 10⁻² micron.

5. A process for manufacturing of a milk mineral water of claim 1 by reverse osmosis of milk, sweet whey or acid whey, alternatively a milk, sweet whey or acid whey based ultrafiltration (UF) permeate.

6. A process of claim 5, wherein the reverse osmose membrane has a pore size between 10⁻⁴ and 10⁻³ micron.

7. A process for manufacturing of a milk mineral water of claim 1 by nanofiltration of milk, sweet whey or acid whey, alternatively a milk, sweet whey or acid whey based ultrafiltration (UF) permeate mixed with either a milk, sweet whey or acid whey based evaporation condensate or alternatively a milk, sweet whey or acid whey based reverse osmosis (RO) permeate.

8. A process of claim 3, 5 or 7, where calcium from milk or another dairy product is added to the desired level.

9. A beverage containing a milk mineral water of claim 1 as essentially sole liquid, and one or more of the following ingredients: a natural milk mineral concentrate, a food grade acid, a food grade sweetener, a food grade colorant, a food grade flavouring agent, a fruit juice, a fruit pulp, vitamins, plant extracts and carbonization.

10. A beverage containing a milk mineral water of claim 1 as essentially sole liquid, which beverage is a soft drink, a food supplement or a natural medicinal product.
